(19) United States
(12) Patent Application Publication
(10) Pub. No.: US 2017/0096505 A1
(43) Pub. Date: Apr. 6, 2017

(54) ACRYLIC ACID-BASED POLYMER COMPOSITION, METHOD FOR PRODUCING SAME, AND USE THEREFOR

(71) Applicant: TOAGOSEI CO., LTD., Minato-ku (JP)

(72) Inventor: Masahiro FUJIWARA, Nagoya-shi (JP)

(73) Assignee: TOAGOSEI CO., LTD., Minato-ku (JP)

(21) Appl. No.: 15/381,139

(22) Filed: Dec. 16, 2016

Related U.S. Application Data
(62) Division of application No. 14/404,680, filed on Dec. 1, 2014.

(30) Foreign Application Priority Data
Jul. 23, 2012 (JP) 2012-162769

(51) Int. Cl. C08F 120/06; C11D 3/37; C09B 67/46

(52) U.S. Cl. CPC C08F 120/06; C09B 67/009; C11D 3/3757

(57) ABSTRACT

An acrylic acid-based polymer composition of the present invention is obtained using a hypophosphorous acid compound in an amount of 0.5 to 4.5 parts by mass based on 100 parts by mass of a total of monomers for forming structural units of the acrylic acid-based polymer and adding 1% to 500 by mass of a total amount of the hypophosphorous acid compound to a reactor before supplying the monomer. The phosphorous acid ion is contained in an amount of 20 to 1,000 ppm by mass based on a solid content of the acrylic acid-based polymer.

### TECHNICAL FIELD

The present invention relates to an acrylic acid-based polymer composition and a production method thereof and to a use therefor. More specifically the present invention relates to an acrylic acid-based polymer composition and a production method thereof that are useful for a dispersant, a detergent, or an inorganic precipitation inhibitor.

### BACKGROUND ART

An acrylic acid-based polymer such as sodium polyacrylate is an industrially important compound that is widely used for various applications such as a pigment dispersant, a detergent builder, or an inorganic precipitation inhibitor. The acrylic acid-based polymer has a low molecular weight, that is, a weight average molecular weight of about 1,000 to 30,000, and an acrylic acid-based polymer having narrow molecular weight distribution is preferably used. To obtain such a low-molecular weight polymer, the molecular weight is adjusted typically by using a chain transfer agent, and various chain transfer agents such as a mercapto compound, a bisulfite compound, a hypophosphorous acid compound, or an alcohol compound are used.

Among them, when sodium hypophosphite is used, it is known that a polymer having good dispersion performance or the like is obtained, and various polymers and methods for producing them are disclosed.

In Patent Document 1, a novel cotelomer compound which is effective for suppressing metal corrosion and/or scale precipitation from an aqueous system and/or promoting dispersion of particles in an aqueous system, and a production method therefor are disclosed.

Further, in Patent Document 2, it is shown that a dispersant produced by using sodium hypophosphite as a chain transfer agent is excellent in terms of initial viscosity and suppression of gelling tendency in a dispersion of calcium carbonate particles.

Meanwhile, in Patent Document 3 by the present applicant, an acrylic acid-based polymer obtained by a method which includes a step of polymerizing an acrylic acid-containing monomer in the presence of hypophosphorous acid salt and persulfate with use of an aqueous solution of isopropyl alcohol as a solvent is disclosed, and it is also shown that the polymer exhibits good performance as a dispersant for calcium carbonate.

### PRIOR TECHNICAL DOCUMENT

### Patent Document

[Patent Document 1] JP-A S60-174793

[Patent Document 2] JP-A 2009-242784

[Patent Document 3] WO 2012/8294

### SUMMARY OF THE INVENTION

### Problems that the Invention is to Solve

However, it is necessary to use a large amount of a chain transfer agent such as sodium hypophosphite to obtain a polymer having a low molecular weight when the method described in Patent Document 1 is applied. Accordingly, there has been a problem in that, when it is used as a pigment dispersant, for example, the viscosity of the pigment dispersion increases over time.

No specific description relating to a usage amount of sodium hypophosphite or a temperature condition for polymerization reaction is given in Patent Document 2, and thus there has been a case in which performances, for example, pigment dispersion properties and the like are insufficient depending on the conditions.

Patent Document 3 relates to a technique in which an acrylic acid polymer is produced using a hypophosphorous acid salt in an amount equal to or less than a specific amount to reduce the content of phosphorous acid salt and phosphoric acid salt, that are byproducts generated from hypophosphorous acid salt. However, for manufacturing a coating paper, for example, there is a tendency of requiring high micronization of a dispersion of calcium carbonate for the purpose of having high gloss, and for using it as a dispersant for such application, improvements are still needed in terms of a dispersion property and dispersion stability.

An objective of the present invention is to provide a composition of an acrylic acid-based polymer having a narrow molecular weight distribution and a low molecular weight, which can exhibit very excellent performance when used in an application including a pigment dispersant, a detergent, or an inorganic precipitation inhibitor, and a production method of the composition for efficiently obtaining without using a large amount of a chain transfer agent.

Inventors of the present invention conducted intensive studies in view of the problems described above, found that when a specific content of phosphorous acid ion is contained in an acrylic acid-based polymer composition which includes acrylic acid, and a phosphorous acid compound and/or a hypophosphorous acid compound as a raw material component, an excellent dispersion property can be exhibited, and thus completed the invention.

The present inventions are as follows.

[1] A production method of a composition comprising an acrylic acid-based polymer, characterized in that a hypophosphorous acid compound is used in an amount of 0.5 to 4.5 parts by mass based on 100 parts by mass of a total of monomers for forming structural units of the acrylic acid-based polymer, and that 11 to 50% by mass of a total amount of the hypophosphorous acid compound is added to a reactor before supplying the monomer.
[2] The production method of an acrylic acid-based polymer composition according to [1] above, wherein a mixture solution of water and isopropyl alcohol is used as a polymerization solvent.
[3] The production method of an acrylic acid-based polymer composition according to [1] or [2] above, wherein polymerization temperature is in a range from 68° C. to 82° C.
[4] A composition comprising an acrylic acid-based polymer obtained using acrylic acid and a phosphorous acid compound and/or a hypophosphorous acid compound as a raw material component, wherein a phosphorous acid ion is contained in an amount of 20 to 1,000 ppm by mass based on a solid content of the acrylic acid-based polymer.
[5] The acrylic acid-based polymer composition according to [4] above, wherein the phosphorous acid compound and/or the hypophosphorous acid compound is used as a chain transfer agent.
[6] The acrylic acid-based polymer composition according to [4] or
[5] above, further comprising a hypophosphorous acid ion in an amount of 200 to 5,000 ppm by mass based on a solid content of the acrylic acid-based polymer.
[7] The acrylic acid-based polymer composition according to any one of [4] to [6] above, wherein a weight average molecular weight of the acrylic acid-based polymer is in a range from 3,000 to 30,000.
A dispersant for calcium carbonate comprising an acrylic acid-based polymer composition obtained by the production method according to any one of [1] to [3] above, or an acrylic acid-based polymer composition according to any one [4] to [7] above.
[9] A detergent comprising an acrylic acid-based polymer composition obtained by the production method according to any one of [1] to [3] above, or an acrylic acid-based polymer composition according to any one [4] to [7] above.
[10] An inorganic precipitation inhibitor comprising an acrylic acid-based polymer composition obtained by the production method according to any one of [1] to [3] above, or an acrylic acid-based polymer composition according to any one [4] to [7] above.

### EFFECT OF THE INVENTION

Since the acrylic acid-based polymer composition of the present invention has an excellent dispersion property and dispersion stability, the composition exhibits excellent performances in applications like a dispersant for an inorganic pigment including calcium carbonate, a detergent, and an inorganic precipitation inhibitor.

Further, according to the method for producing an acrylic acid-based polymer composition of the present invention, the acrylic acid-based polymer can be produced efficiently without using a large amount of a chain transfer agent, or the like.

### EMBODIMENTS FOR CARRYING OUT THE INVENTION

The present invention relates to an acrylic acid-based polymer composition containing a specified volume of phosphite ion and to a production method thereof.

Hereinafter, the present invention is described in detail. In the description of the present invention, “(co)polymer” means a homopolymer and/or a copolymer, and “(meth)acryl” means acryl and/or methacryl.

The acrylic acid-based polymer composition of the present invention includes an acrylic acid-based polymer which has acrylic acid as an essential constitutional monomer component. Thus, the acrylic acid-based polymer may be either a homopolymer of acrylic acid or a copolymer containing acrylic acid in a part of the constitutional monomer.

A monomer other than acrylic acid (hereinafter, referred to as “other monomer”) is not particularly limited so long as it is a monomer copolymerizable with acrylic acid. Specific example thereof is a radical polymerizable vinyl-based monomer (polymerizable unsaturated compound). Examples of the vinyl-based monomer include an ethylenically unsaturated carboxylic acid other than acrylic acid, a neutralized salt of an ethylenically unsaturated carboxylic acid, a (meth)acrylic acid alkyl ester compound, an aromatic vinyl compound, an acid anhydride, a vinyl compound having an amino group, a vinyl compound having an amide group, a vinyl group having a sulfonic acid group, a vinyl group having a polyoxyalkylene group, a vinyl compound having an alkoxy group, a vinyl compound having a cyano group, a cyanidated vinyl compound, a vinyl ether compound, a vinyl ester compound, a conjugated diene, and the like. These compounds may be used singly or in combination of two or more types thereof.

Among them, from the viewpoint of physical properties such as dispersion stability and suppressed coloration of a resulting dispersant, a (meth)acrylic acid alkyl ester compound and a vinyl compound having a polyoxyalkylene group are preferable.

Examples of the ethylenically unsaturated carboxylic acid other than acrylic acid include methacrylic acid, ethacrylic acid, maleic acid, fumaric acid, itaconic acid, crotonic acid, a product of half-esterification of phthalic acid anhydride with an alkyl alcohol, a product of half-esterification of itaconic acid anhydride with an alkyl alcohol, and the like.

Examples of the neutralized salt of an ethylenically unsaturated carboxylic acid include a salt of ethylenically unsaturated carboxylic acid in which a carboxyl group in acrylic acid, methacrylic acid, ethacrylic acid, maleic acid, fumaric acid, itaconic acid, or crotonic acid is neutralized. Further, examples of the salt of ethylenically unsaturated carboxylic acid include an alkali metal salt, an alkali earth metal salt, an ammonium salt, an organic amine salt, and the like.

Examples of the (meth)acrylic acid alkyl ester compound include methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, n-pentyl (meth)acrylate, isoamyl (meth)acrylate, n-hexyl (meth)acrylate, 2-methylpentyl (meth)acrylate, n-octyl (meth)acrylate, 2-ethylhexyl (meth)acrylate, n-decyl (meth)acrylate, n-dodecyl (meth)acrylate, n-octadecyl (meth)acrylate, isobornyl (meth)acrylate, cyclohexyl (meth)acrylate, phenyl (meth)acrylate, benzyl (meth)acrylate, and the like.

Examples of the aromatic vinyl compound include styrene, 2-methyl styrene, 3-methyl styrene, 4-methyl styrene, a-methyl styrene, 2,4-dimethyl styrene, 2,4-diisopropyl styrene,4-tert-butyl styrene, tert-butoxy styrene, vinyl toluene, vinyl naphtharene, halogenized styrene, styrene sulfonic acid, a-methyl styrene sulfonic acid, and the like.

Examples of the acid anhydride monomer include maleic acid anhydride, itaconic acid anhydride, citraconic acid anhydride, and the like.

Examples of the vinyl compound having an amino group include dimethylaminomethyl (meth)acrylate, diethylaminomethyl (meth)acrylate, 2-dimethylaminoethyl (meth)acrylate, 2-diethylaminoethyl (meth)acrylate, 2-(di-n-propylamino)ethyl (meth)acrylate, 2-dimethylaminopropyl (meth)acrylate, 2-diethylaminopropyl (meth)acrylate, 2-(di-n-propylamino)propyl (meth)acrylate, 3-dimethylaminopropyl (meth)acrylate, 3-diethylaminopropyl (meth)acrylate, 3-(di-n-propylamino)propyl (meth)acrylate, and the like.

Examples of the vinyl compound having an amide group include (meth)acrylamide, N,N-dimethyl (meth)acrylamide, N,N-dimethylaminopropyl (meth)acrylamide, N-methylol (meth)acrylamide, and the like.

Examples of the vinyl compound having a sulfonic acid group include methallyl sulfonic acid, acrylamide-2-methyl-2-propane sulfonic acid, and the like.

Examples of the vinyl compound having a polyoxyalkylene group include (meth)acrylic acid ester of an alcohol having a polyoxyethylene group and/or a polyoxypropylene group, and the like.

Examples of the vinyl group having an alkoxy group include 2-methoxyethyl (meth)acrylate, 2-ethoxyethyl (meth)acrylate, 2-(n-propoxy)ethyl (meth)acrylate, 2-(n-butoxy)ethyl (meth)acrylate, 3-methoxypropyl (meth)acrylate, 3-ethoxypropyl (meth)acrylate, 2-(n-propoxy)propyl (meth)acrylate, 2-(n-butoxy)propyl (meth)acrylate, and the like.

Examples of the (meth)acrylic acid ester compound having a cyano group include cyanomethyl (meth)acrylate, 1-cyanoethyl (meth)acrylate, 2-cyanoethyl (meth)acrylate, 1-cyanopropyl (meth)acrylate, 2-cyanopropyl (meth)acrylate, 3-cyanopropyl (meth)acrylate, 4-cyanobutyl (meth)acrylate, 6-cyanohexyl (meth)acrylate, 2-ethyl-6-cyanohexyl (meth)acrylate, 8-cyanooctyl (meth)acrylate, and the like.

Examples of the cyanidated vinyl compound include acrylonitrile, methacrylonitrile, ethacrylonitrile, and the like.

Examples of the vinyl ether compound include vinyl methyl ether, vinyl ethyl ether, vinyl n-butyl ether, vinyl phenyl ether, vinyl cyclohexyl ether, and the like. These compounds may be used singly or in combination of two or more types thereof.

Examples of the vinyl ester monomer include vinyl formate, vinyl acetate, vinyl propionate, and the like.

Examples of the conjugated diene include 1,3-butadiene, isoprene, 2,3-dimethyl-1,3-butadiene, 1,3-pentadiene, 2-methyl-1,3-pentadiene, 1,3-hexadiene, 4,5-diethyl-1,3-octadiene, 3-butyl-1,3-octadiene, chloroprene, and the like.

Other examples include a maleimide-based compound such as maleimide, N-methyl maleimide, N-butyl maleimide, N-phenyl maleimide, and N-cyclohexyl maleimide; a maleic acid ester compound; an itaconic acid ester compound; an N-vinyl heterocyclic compound such as vinyl pyridine; and the like.

Among those other monomers, preferred are maleic acid anhydride, acrylamide-2-methyl-2-propanesulfonic acid, and the like. In the case of using those monomers in combination with acrylic acid, excellent adsorption to a pigment and excellent affinity for a solvent are obtained when used for a pigment dispersant, for example, and thus the dispersibility can be improved.

In the polymerization for the acrylic acid-based polymer, when the monomer includes a monomer other than acrylic acid, content of the acrylic acid is preferably 80% or more by mass, more preferably 90% or more by mass, and further preferably 95% or more by mass, relative to 100% by mass of the total amount of the monomer. In the present invention, especially preferred is to have 100% by mass of acrylic acid for the total amount of the monomer. When the content of the acrylic acid is 80% or more by mass, the resulting dispersant can have sufficient solubility in water.

In the acrylic acid-based polymer composition of the present invention, a phosphorous acid compound and/or a hypophosphorous acid compound is used as a raw material component. Specific examples of the compound include phosphorous acid, hypophosphorous acid, and a sodium salt, potassium salt, lithium salt, calcium salt, magnesium salt, and barium salt of those acids. These compounds may be used singly or in combination of two or more types thereof. Among these, sodium phosphite and sodium hypophosphite are preferable from the viewpoint of leading to good performance, such as dispersion property by an acrylic acid-based polymer composition to be obtained. In particular, sodium hypophosphite is preferred.

Further, the phosphorous acid compound and/or hypophosphorous acid compound can be used in any step for producing an acrylic acid-based polymer composition. For example, it may be used as a chain transfer agent for a polymerization reaction to obtain an acrylic acid-based polymer or added and mixed after completion of the polymerization reaction.

The acrylic acid-based polymer composition of the present invention contains phosphorous acid ion in an amount of 20 to 1,000 ppm by mass based on the solid content of the acrylic acid-based polymer. The concentration of the phosphorous acid ion can be adjusted by adding a phosphorous acid compound in any step for producing the acrylic acid-based polymer composition. Further, when a hypophosphorous acid compound is used as a chain transfer agent, phosphorous acid ion is generated as a byproduct according to oxidation of the corresponding hypophosphorous acid compound, depending on use conditions thereof. In the present invention, origin of the phosphorous acid ion contained in an acrylic acid-based polymer composition is not important.

If the content of the phosphorous acid ion is less than 20 ppm by mass or more than 1,000 ppm by mass, performances of the acrylic acid-based polymer composition such as a dispersion property or a property of inhibiting precipitation of inorganic substances may become insufficient. The content of the phosphorous acid ion is preferably in a range from 30 to 500 ppm by mass, and more preferably from 50 to 200 ppm by mass.

As described above, a phosphorous acid ion concentration of 20 to 1,000 ppm by mass in the acrylic acid-based polymer composition leads to an excellent dispersion property or a property of inhibiting precipitation of inorganic substances in the present invention.

Although the effect of the phosphorous acid ion concentration on performances such as a dispersion property remains unclear, it is estimated that, by having a small amount of phosphorous acid salt, the adsorption property of an acrylic acid-based polymer as a dispersant is enhanced. Further, since the phosphorous acid salt such as calcium phosphorous acid is a salt that is poorly soluble in water, it is believed that, when the phosphorous acid ion is present in a large amount, a poorly soluble compound derived from the ion is formed so that the dispersion performance is deteriorated accordingly. Meanwhile, the present invention is not limited to those mechanisms.

The acrylic acid-based polymer composition of the present invention contains hypophosphorous acid ion in an amount of preferably from 200 to 5,000 ppm by mass, more preferably from 500 to 4,000 ppm by mass, and further preferably from 1,000 to 3,000 ppm by mass based on the solid content of the acrylic acid-based polymer.

When the content is 200 ppm by mass or more, the dispersion property or the like of the acrylic acid-based polymer composition tends to be improved. For example, calcium hypophosphorous acid consisting of hypophosphorous acid ion and calcium ion is a compound having relatively high solubility in water. For such reasons, when a calcium compound is dispersed by using a polymer composition containing hypophosphorous acid ion, precipitation of the calcium compound can be inhibited, and thus it presumably contributes to improvement of dispersion performance.

Meanwhile, if the hypophosphorous acid ion concentration is excessively high, a ratio of the acrylic acid-based polymer, which is an effective component in the composition, is lowered, and thus the upper limit is preferably 5,000 ppm by mass or so.

The hypophosphorous acid ion concentration can be adjusted only by a usage amount of the hypophosphorous acid compound described below.

The weight average molecular weight (Mw) of the acrylic acid-based polymer of the present invention is preferably in a range from 3,000 to 30,000, more preferably from 3,000 to 20,000, and further preferably from 4,000 to 10,000. If the weight average molecular weight is lower than 3,000, the dispersion stability may become insufficient when the acrylic acid-based polymer is used as a dispersant or the like. If the weight average molecular weight is higher than 30,000, a ratio of a high molecular weight polymer which is inappropriate for dispersion is increased so that a poor dispersibility may be yielded. The weight average molecular weight can be measured by gel permeation chromatography (GPC) using a standard material such as sodium polyacrylate.

With regard to the method for producing an acrylic acid-based polymer of the present invention, a hypophosphorous acid compound is used as a chain transfer agent. A usage amount of the compound is in a range from 0.5 to 4.5 parts by mass, preferably from 1.0 to 4.0 parts by mass, and more preferably from 1.5 to 3.5 parts by mass based on 100 parts by mass of monomer. When the usage amount of the hypophosphorous acid compound is within the above range, a polymer having a weight average molecular weight of 3,000 to 30,000 is efficiently obtained. Further, a concentration of hypophosphorous acid ion in the acrylic acid-based polymer composition can be set within the preferred range. Further, when the usage amount of the hypophosphorous acid compound is 4.5 parts by mass or less, it becomes easier to adjust the phosphorous acid ion concentration to 1,000 ppm by mass or less.

Further, it is necessary that an amount corresponding to 1% to 50% by mass, preferably 5% to 40% by mass, and more preferably 10% to 30% by mass based on a total amount of the hypophosphorous acid compound is added to a reactor before supplying monomers.

When the hypophosphorous acid compound is charged to a reactor in an amount of 1% by mass or more of the total amount of the compound before supplying monomers, it becomes easier to adjust the phosphorous acid ion concentration in an acrylic acid-based polymer composition to be obtained to the amount defined by the present invention (20 ppm by mass). Further, when the hypophosphorous acid compound is charged to a reactor in an amount of 50% by mass or less, it becomes easier to adjust the phosphorous acid ion concentration in an acrylic acid-based polymer composition to be obtained to be equal to or lower than the upper limit defined by the present invention (1,000 ppm by mass).

As described above, the acrylic acid-based polymer used in applications including a dispersant for an inorganic pigment, a builder for a detergent, and an inorganic precipitation inhibitor is preferably an acrylic acid-based polymer having a low molecular weight such as weight average molecular weight ranging from 3,000 to 30,000, and it is preferable that the molecular weight distribution is as narrow as possible.

On the other hand, a polymer having a high molecular weight of, for example, 100,000 or higher not only increases a viscosity of a system but also may crosslink the particles in dispersoid due to adsorption onto a surface of plural dispersoids, and therefore it is an inappropriate component for dispersion. Thus, it is preferable to contain the high molecular weight component as little as possible.

The production method of the acrylic acid-based polymer is not particularly limited. It has preferably an aqueous solution polymerization. With an aqueous solution polymerization, a dispersant can be obtained as a homogeneous solution.

As a polymerization solvent for aqueous solution polymerization, water or a mixture solution of water and an organic solvent can be used. Examples of a preferable organic solvent at a time of using a mixture solution of water and an organic solvent include an alcohol such as isopropyl alcohol and a ketone such as acetone. Isopropyl alcohol is especially preferred.

Since a water/isopropyl alcohol mixture solution can be used both as a reaction solvent and a chain transfer agent, when a phosphorous acid compound and/or a hypophosphorous acid compound is used as a chain transfer agent, the usage amount of the mixture solution can be reduced, being desirable.

The concentration of isopropyl alcohol in an aqueous solution of isopropyl alcohol is preferably 5% by mass or more but 90% by mass or less, more preferably in a range from 10% to 80% by mass, further preferably from 15% to 60% by mass, and especially from 15% to 55% by mass. The concentration may be in a range from 20% to 50% by mass or 30% to 50% by mass.

When the concentration of isopropyl alcohol is 5% by mass or more, the chain transfer effect of isopropyl alcohol as a chain transfer agent is exhibited effectively. Further, as the concentration of isopropyl alcohol increases, more excellent chain transfer effect is obtained according to the increase.

A usage amount of isopropyl alcohol in the polymerization step is preferably in a range from 15 to 80 parts by mass, and more preferably from 45 to 75 parts by mass based on 100 parts by mass of the monomer. When the usage amount of isopropyl alcohol is 15 parts by mass or more, the chain transfer effect of isopropyl alcohol is effectively exhibited. Further, when it is 80 parts by mass or less, the solubility of a raw material is improved.

When a mixture solution of water and isopropyl alcohol is used as a polymerization solvent, isopropyl alcohol can be distilled and extracted outside the system by lowering the pressure of the reaction system and/or heating the reaction system after completing the polymerization reaction. Accordingly, isopropyl alcohol can be distilled off from the reaction solution. Further, isopropyl alcohol removed by distillation is generally an azeotropic mixture with water. As such, isopropyl alcohol is distilled off as an aqueous solution from the reaction solution during the concentration step, and thus a concentrated composition with reduced isopropyl alcohol and water is yielded.

A method for distilling isopropyl alcohol during the concentration step is not particularly limited. When the reaction system is, subjected to, for example, being under reduced pressure and maintaining the internal temperature at the azeotropic temperature of isopropyl alcohol or higher, water and isopropyl alcohol can be distilled and extracted outside the system. Further, it is also possible that water and isopropyl alcohol are distilled and extracted outside the system by haying the reaction solution flow through a thin film evaporator under reduced pressure.

A content of isopropyl alcohol in the condensed composition which is obtained by condensation step is preferably 1% by mass or less, more preferably 5,000 ppm by mass or less, further preferably 2,000 ppm by mass or less, and especially 1,000 ppm by mass or less.

In the polymerization reaction, a publicly known polymerization initiator can be used and a radical polymerization initiator is preferably used in particular.

Examples of the radical polymerization initiator include a water soluble peroxide such as a persulfate including sodium persulfate, potassium persulfate and ammonium persulfate, a hydroperoxide including t-butyl hydroperoxide, and hydrogen peroxide; an oil-soluble peroxide such as a ketone peroxide including methyl ethyl ketone peroxide and cyclohexanone peroxide, a dialkyl peroxide including di-t-butyl peroxide and t-butyl cumyl oxide; an azo compound such as 2,2′-azobis(2-methylpropionamidine)dihydrochloride; and the like.

The peroxide radical polymerization initiator may be used singly or in combination of two or more types thereof.

Among the peroxide radical polymerization initiators described above, a persulfate and an azo compound are preferable from the viewpoint of easy control of the polymerization reaction, and a persulfate is especially preferred.

The radical polymerization initiator is diluted in an aqueous medium, for example, and supplied to a reactor via a supply port which is different from the one for the monomer.

A usage amount of the radical polymerization initiator is not particularly limited and is preferably in a range from 0.1% to 15% by weight, and especially from 0.5% to 10% by weight based on a total weight of the entire monomer for the acrylic acid-based polymer. The ratio of 0.1% by weight or higher leads to an improved (co)polymerization rate. The ratio of 15% by weight or lower leads to an improved stability of the resulting polymer and excellent performances can be obtained when it is used as a dispersant or the like.

Further, a water soluble redox polymerization initiator may be used as a polymerization initiator for the production, if necessary. Examples of the redox polymerization initiator include a combination of an oxidizing agent (for example, the aforementioned peroxide) and a reducing agent such as sodium bisulfite, ammonium bisulfite, sodium sulfite, and sodium hydrosulfite, or iron alum, potassium alum.

The polymerization temperature for the polymerization reaction to obtain the acrylic acid-based polymer is preferably in a range from 68° C. to 82° C., and more preferably from 70° C. to 80° C. The polymerization temperature of 68° C. or higher leads to a reduction of an amount of unreacted monomer. At a high temperature like the temperature higher than 82° C. in particular, a hypophosphorous acid compound is oxidized to a phosphorous acid compound or the like when it is used as a chain transfer agent. For such reasons, when the polymerization is conducted at a temperature of 82° C. or lower, the phosphorous acid ion concentration in the acrylic acid-based polymer composition can be easily controlled to a value equal to or lower than the value defined in the present invention. Meanwhile, as described herein, the polymerization temperature includes not only a temperature for polymerization reaction but also a temperature for the aging step thereafter.

The polymerization method can be any one of a batch type polymerization and a continuous type polymerization. In the case of a batch type polymerization, a time required for a supplying step of a raw material (a raw material composition) containing monomers is preferably in a range from 2 to 12 hours, and more preferably from 3 to 8 hours. When the time required is equal to or longer than 2 hours, removal of polymerization heat is facilitated, and when it is equal to or shorter than 12 hours, the productivity is enhanced, being desirable.

In the case of a continuous type polymerization, the process is preferably based on a multi-level CSTR (continuous stirred tank reactor having plural reaction tanks). In such case, an average retention time in each reaction tank is preferably in a range from 60 to 240 minutes, and more preferably from 80 to 180 minutes. When the average retention time is 60 minutes or longer, the unreacted monomer can be reduced. Further, when it is 240 minutes or shorter, the reaction tank size can be reduced.

Specific operation method for the polymerization reaction described above is not particularly limited. Examples include the following embodiments (1) to (3).

(1) A predetermined amount of polymerization solvent (water or water/alcohol) is charged to a reaction vessel and maintained therein. A polymerization initiator and a raw material mixture consisting of a monomer, a polymerization solvent for dilution, and a chain transfer agent are then added dropwise thereto and polymerization reaction is conducted.

(2) A raw material mixture consisting of a monomer, a polymerization solvent, and a chain transfer agent is prepared. The mixture is then added dropwise to a reaction vessel along with a polymerization initiator and polymerization reaction is conducted.

(3) A predetermined amount of a polymerization solvent is charged to a reaction vessel, and it is heated to a temperature equal or nearby the reaction temperature and maintained at the same temperature. After that, a monomer, a chain transfer agent, and a polymerization initiator are added dropwise thereto and polymerization reaction is conducted.

Among these methods, the embodiment (1) is preferred in that a homogeneous polymer is obtained.

Specific method of the embodiment (1) is as follows. predetermined amount, for example, 20% to 80% by mass of total usage amount of a polymerization solvent (water or water/alcohol) is maintained in a reaction vessel at a temperature equal or nearby the reaction temperature in advance. Meanwhile, a raw material mixture consisting of the polymerization solvent which remains after charging to the reaction vessel, a monomer, and a chain transfer agent (phosphite and/or hypophosphite) is prepared. After that, the raw material mixture and a polymerization initiator are added dropwise to the reaction vessel and polymerization reaction is conducted.

To control pH of the reaction solution during polymerization reaction or pH of the acrylic acid-based polymer solution obtained as a final product, an alkaline agent (neutralizing agent) is used. Specific example thereof includes an alkali metal hydroxide such as sodium hydroxide and potassium hydroxide; an alkali earth metal hydroxide such as calcium hydroxide and magnesium hydroxide; ammonia; an organic amine such as monoethanolamine, diethanolamine, and triethanolamine; and the like. The alkaline agent may be used singly or in combination of two or more types thereof. Among those basic compounds, an alkali metal hydroxide having little production of volatile components is preferable. Sodium hydroxide is more preferable.

Since the acrylic acid-based polymer composition of the present invention contains phosphorous acid ion at specific concentration, the composition exhibits an excellent performance in an application such as a pigment dispersant, a detergent, and an inorganic precipitation inhibitor. The dispersant for a pigment can be used as a dispersant for obtaining an aqueous dispersion liquid for various pigments, and is particularly useful as a dispersant for obtaining a dispersion of inorganic pigment consisting of calcium carbonate or the like.

When the acrylic acid-based polymer composition of the present invention is used as a dispersant to prepare a calcium carbonate slurry, a blending amount of the dispersant is not particularly limited. The composition is preferably used so that an amount of the acrylic acid-based polymer is in a range from 0.1 to 10.0 parts by mass and an amount of the aqueous medium is in a range from 25 to 100 parts by mass based on 100 parts by mass of calcium carbonate.

After that, a mixture of calcium carbonate and a dispersant containing the acrylic acid-based polymer is subjected to wet grinding based on publicly known method to prepare a calcium carbonate slurry.

When the acrylic acid-based polymer composition of the present invention is used as a dispersant, the dispersion property for calcium carbonate is excellent so that it is preferably used as a dispersant for calcium carbonate for the case of obtaining a calcium carbonate slurry after wet grinding of calcium carbonate. The calcium carbonate slurry obtained using the dispersant of the present invention has low initial viscosity, and as the significant viscosity increase over time is inhibited, it can be provided as a slurry having excellent dispersion stability for a long period of time.

### EXAMPLES

Hereinafter, the present invention is specifically described using Examples. In the following, “part(s)” means part(s) by mass, and “%” means by mass.

Solid content of a polymer or the like obtained in each example was measured according to the following method.

### <Solid Content>

About 1 g of an applicable measurement sample was weighed (a), followed by measurement (b) of a residue after drying the sample at a temperature of 155° C. for 30 minutes by an air blow dryer, thereby calculating a solid concentration of the sample by the following equation. Used for the measurement was a weighing bottle. The other manipulations were conducted according to JIS K 0067-1992 (Test methods for loss and residue of chemical products).

Solid content (%)=(b/a)×100

### Example 1

500 g of an aqueous solution of isopropyl alcohol (hereinafter, referred to as “IPA”) with a concentration of 36% and 3 g of sodium hypophosphite were charged to a flask equipped with a stirrer and a condenser, and a mixture was maintained at a temperature of 75° C. To the flask, a mixed liquid of 600 g of acrylic acid, 17 g of sodium hypophosphite, and 270 g of an aqueous solution of IPA with a concentration of 36% and 40 g of 15% aqueous solution of sodium persulfate were supplied over four hours. Once the dropwise addition is completed, the reaction solution was maintained at a temperature of 75° C. for 1 hour. Subsequently, IPA was distilled off under reduced pressure while adding deionized water until the IPA concentration becomes 1,000 ppm or less. The reaction solution was then maintained at 75° C. and 32% aqueous solution of sodium hydroxide and deionized water were supplied thereto. Accordingly, an acrylic acid-based polymer composition E1 with a concentration of solid content of 40% and pH 6 was obtained.

A weight average molecular weight (Mw) of E1 was measured by gel permeation chromatography (GPC). Measurement conditions for GPC are as follows. HLC8020 system manufactured by Tosoh Corporation was used, G4000PW×1, G3000PW×1, and G2500PW×1 manufactured by Tosoh Corporation were connected and used as a column, 0.1 M NaCl and a phosphate buffer (pH 7) were used as an elution solution, and calibration curve was established using sodium polyacrylate manufactured by Sowa Science Corporation. As a result of the measurement, Mw was found to be 6,000.

Contents of a phosphorous acid ion and a phosphoric acid ion in E1 were measured by ³¹P-NMR. Measurement conditions for NMR were as follows. JNM-ECA400 manufactured by JEOL, Ltd. was used and deuterated water was used as a solvent. Based on H₃PO₄ as a reference, a peak derived from hypophosphorous acid was obtained near 8.0 ppm and a peak derived from phosphorous acid was obtained near 3.0 ppm. As a result of calculation, it was found that the hypophosphorous acid ion content is 1,700 ppm and the phosphorous acid ion content is 100 ppm.

<Wet Grinding Test with Ground Calcium Carbonate>

A cylindrical container was charged with 30 g of E1, 320 g of ion exchange water, and 1,000 g of ground calcium carbonate “Tankaru A” manufactured by Maruo Calcium Co., Ltd. They were stirred lightly for homogeneous mixing. After that, 3,300 g of media (1 mmφ ceramic beads) was added to the cylindrical container and then wet grinding was carried out by stirring at 1,000 rpm for 50 minutes. The liquid was passed through a 200ME filter cloth, and the slurry was collected. Ion exchanged water was added to this slurry so that a solid content of the resulting slurry was adjusted to 75%. A viscosity of the slurry on that day of the wet grinding and a viscosity of the slurry after being allowed to stand at 25° C. for 7 days were measured using type B viscometer under conditions of 25° C. and 60 rpm. The viscosity of the slurry on the grinding day was 210 mPa·s, and the viscosity after keeping for seven days was 1,800 mPa·s. Further, integrated values under 2 μm or 1 μm of the slurry were measured using a particle size analyzer “SediGrap 5120” manufactured by Micromeritics Instrument Corporation. As a result, the integrated value under 2 μm was 100%, and the integrated value under 1 μm was 84%.

<Dispersion Test with Precipitated Calcium Carbonate>

A cylindrical container was charged with 10 g of E1, 230 g of ion exchange water, and 770 g of precipitated calcium carbonate. After that, stirring was carried out at 4,000 rpm for 10 minutes to prepare a dispersion slurry. A viscosity of the slurry immediately after dispersion and a viscosity of the slurry after being allowed to stand at 25° C. for 7 days were measured using type B viscometer under conditions of 25° C. and 60 rpm. The viscosity of the slurry immediately after dispersion was 290 mPa·s, and the viscosity after keeping for seven days was 1,100 mPa·s.

### <Dispersing of Silt-1>

1.5 g of E1 was added to 200 g of silt-filled water that contains alluvial clay collected from an municipal area of Osaka, and has specific gravity of 1.16, viscosity of 940 mPa·s, and adjusted pH of 7.0 and stirred for 5 minutes. The viscosity immediately after stirring was measured by using type B viscometer under conditions of 25° C. and 60 rpm. As a result, it was found to be 30 mPa·s.

### <Dispersing of Silt-2>

1 g of clay “Amazon 88 Non Predisperse” (trade name) Mitsubishi Corporation, 100 g of ion exchange water, and 13 mg of E1 were added to a 100 mL mess cylinder and stirred for 10 minutes with a magnetic stirrer. After keeping it for 18 hours at a temperature of 25° C., the supernatant liquid was collected and absorbance at a wavelength of 380 nm was measured. The absorbance of the supernatant liquid in which E1 is used was 1.2.

### <Test for Calcium Ion Supplementing Activity>

E1 was added to 100 mL of a 200 mgCa/L calcium chloride solution and 1 mL of 4 N potassium chloride solution to have E1 in an amount of 200 mg-solid and sodium hydroxide was used to adjust to pH 8.5. After keeping it at a temperature of 30° C. for 10 minutes, a concentration of calcium ion remaining in the solution was measured by a calcium ion meter “D-53” (manufactured by HORIBA, Ltd.) having a calcium ion electrode “6583-10C”, and a supplemented calcium ion was calculated. The amount of calcium ion captured by E1 was 430 mgCaCO₃/g.

### <Calcium Carbonate Scale Inhibition Test>

E1 was added to 100 mL of a 50 mgCa/L calcium chloride solution to have E1 in an amount of 200 mg-solid and sodium hydroxide was used to adjust to pH 8.5. 10 g of 3% sodium hydrogen carbonate solution was added and then it was kept at a temperature of 70° C. for 3 hours. Precipitates were separated by filtration, a calcium concentration in the filtrate was obtained by EDTA titration, and a scale inhibition ratio was calculated. The calcium carbonate scale inhibition ratio of E1 was 75%.

### <Detergency Test>

20% of dodecyl benzene sulfonic acid, 10% of sodium silicate, 10% of anhydrous sodium carbonate, 40% of anhydrous sodium sulfate, and 20% of E1 were used to prepare a detergent composition. 1 g of the detergent composition and 1 L of tap water from city of Nagoya were contained to a stirring type washing test device, and then five pieces of artificially soiled cloth (10 cm×10 cm, prepared by Cleaning Science Association) were added thereto. Subsequently these soiled cloths were washed at a temperature of 25° C. for 5 minutes, and rinsing was performed for 5 minutes. After that the washed cloths were dried, reflectance on a surface of the cloth was measured by using a surface reflection tester. A detergency ratio was calculated using the following equation, and it was found to be 55%.

Detergency ratio (%)=(R_{W}-R_{S})/(R₀-R_{S})×100

In the equation,

R_{W}: Surface reflectance of artificially soiled cloth after washing

R_{S}: Surface reflectance of artificially soiled cloth

R₀: Surface reflectance of white cloth before soiling

### Examples 2 to 4, 6 to 7, and 9 to 19

The acrylic acid-based polymer compositions E2 to E4, E6 to E7, and E9 to E19 were obtained in the same manner as Example 1 except that the production conditions including a raw material feed amount or an addition method for the raw material were modified to those shown in Tables 1 to 3. Physical properties and evaluation results of each polymer composition obtained are also described in Tables 1 to 3.

### Examples 5 and 8

Sodium phosphite and sodium hypophosphite were added respectively to polymer compositions E4 and E7 obtained from Examples 4 and 7, and acrylic acid-based polymer compositions E4 and E7 were obtained. Physical properties and evaluation results of each polymer composition obtained are also described in Table 1.

### Comparative Examples 1, 2 and 4 to 6

The acrylic acid-based polymer compositions C1, C2 and C4 to C6 were obtained in the same manner as Example 1 except that the production conditions including a raw material feed amount or an addition method for the raw material were modified to those shown in Table 4. Physical properties and evaluation results of each polymer composition obtained are also described in Table 4.

### Examples 20 and 21

Sodium phosphite was added to the acrylic acid-based polymer composition C2 obtained in Comparative Example 2, and an acrylic acid-based polymer composition E20 was obtained. Similarly, sodium phosphite and sodium, hypophosphite were added to C2, and an acrylic acid-based polymer composition E21 was obtained. Physical properties and evaluation results of each polymer composition obtained are also described in Table 4.

### Comparative Example 3

Sodium hypophosphite was added to the acrylic acid-based polymer composition C2 obtained from Comparative Example 2, and an acrylic acid-based polymer composition C3 was obtained. Physical properties and evaluation results of the polymer composition obtained are also described in Table 4.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| | | | Acrylic acid-based polymer composition | | | | | | | | |
| | | | E1 | E2 | E3 | E4 | E5 | E6 | E7 | E8 | E9 |
| Production | IPA aqueous solution (initial) | (g) | 500 | 500 | 500 | 500 | Same | 500 | 500 | Same | 500 |
| conditions | | | | | | | as E4 | | | as E7 | |
| | Sodium hypophosphite (initial) | (g) | 3 | 2 | 2 | 1 | | 3 | 1 | | 5 |
| | Acrylic acid | (g) | 600 | 600 | 600 | 600 | | 600 | 600 | | 600 |
| | Sodium hypophosphite (continuous) | (g) | 17 | 13 | 8 | 7 | | 20 | 4 | | 20 |
| | 15% Aqueous solution of sodium persulfate | (g) | 40 | 35 | 30 | 40 | | 40 | 40 | | 40 |
| | IPA concentration in IPA aqueous solution | (%) | 36 | 36 | 50 | 36 | | 36 | 36 | | 36 |
| | IPA aqueous solution (monomer dilution) | (g) | 270 | 270 | 270 | 270 | | 270 | 270 | | 270 |
| | Sodium hypophosphite (total) | (part) | 3.3 | 2.5 | 1.7 | 1.3 | | 18 | 0.8 | | 4.2 |
| | Sodium hypophosphite (initial) | (%) | 15 | 13 | 20 | 13 | | 13 | 20 | | 20 |
| | Sodium persulfate | (part) | 1.0 | 0.9 | 0.8 | 1.0 | | 1.0 | 1.0 | | 1.0 |
| | Polymerization temperature | (° C.) | 75 | 80 | 70 | 75 | | 75 | 75 | | 75 |
| | Time for supplying monomer | (Hr) | 4 | 4 | 4 | 4 | | 4 | 4 | | 4 |
| | Post addition | | — | — | — | — | (a) + (b) | — | — | (a) + (b) | — |
| Product | Solid content | (%) | 40 | 40 | 40 | 40 | 40 | 40 | 40 | 40 | 40 |
| | PH | | 6 | 5 | 7 | 6 | 6 | 6 | 6 | 6 | 6 |
| | Mw | | 6000 | 9000 | 6000 | 12000 | 12000 | 3700 | 18000 | 18000 | 3200 |
| | Phosphorous acid ion | (ppm) | 100 | 80 | 60 | 40 | 150 | 400 | 25 | 150 | 800 |
| | Hypophosphorous acid ion | (ppm) | 1900 | 1500 | 1100 | 800 | 1500 | 3400 | 400 | 1500 | 4600 |
| | Remained acrylic acid | (ppm) | <100 | <100 | <100 | <100 | <100 | <100 | <100 | <100 | <100 |
| Wet grinding | Integrated value under 2 μm | (%) | 100 | 100 | 100 | 100 | 100 | 100 | 100 | 100 | 100 |
| test with ground | Integrated value under 1 μm | (%) | 84 | 84 | 84 | 84 | 84 | 84 | 84 | 84 | 84 |
| calcium carbonate | Slurry viscosity on grinding day | (mPa · s) | 200 | 210 | 200 | 270 | 240 | 270 | 300 | 240 | 300 |
| | Slurry viscosity after 7 days | (mPa · s) | 1800 | 1900 | 1900 | 2600 | 2200 | 2600 | 3000 | 2100 | 3100 |
| Dispersion test | Slurry viscosity immediately after | (mPa · s) | 290 | 290 | 290 | 340 | 310 | 350 | 370 | 320 | 380 |
| with precipitated | dispersing | | | | | | | | | | |
| calcium carbonate | Slurry viscosity after 7 days | (mPa · s) | 1100 | 1100 | 1000 | 1700 | 1300 | 1800 | 2300 | 1300 | 2400 |
| Silt dispersion-1 | Viscosity immediately after stirring | (mPa · s) | 30 | 29 | 30 | 38 | 33 | 38 | 43 | 33 | 42 |
| Silt dispersion-2 | Absorbance of supernatant liquid | | 1.2 | 1.2 | 1.3 | 0.9 | 1.0 | 0.9 | 0.7 | 1.0 | 0.7 |
| Ca capturing | Captured calcium ion | (mgCaCO3/g) | 430 | 430 | 430 | 400 | 420 | 400 | 360 | 420 | 370 |
| activity | | | | | | | | | | | |
| Scale inhibition test | Calcium carbonate scale inhibition ratio | (%) | 76 | 75 | 76 | 69 | 73 | 69 | 65 | 72 | 66 |
| Detergency test | Detergency ratio | (%) | 56 | 56 | 57 | 49 | 52 | 49 | 46 | 53 | 46 |

TABLE 2

| | | | Example | | | | | |
|---|---|---|---|---|---|---|---|---|
| | | | 10 | 11 | 12 | 13 | 11 | 15 |
| | | | Acrylic acid-based polymer composition | | | | | |
| | | | E10 | E11 | E12 | E13 | E14 | E15 |
| Production | IPA aqueous solution (initial) | (g) | 500 | 500 | 500 | 500 | 500 | 500 |
| conditions | Sodium hypophosphite (initial) | (g) | 1.5 | 7 | 0.5 | 9 | 3 | 3 |
| | Acrylic acid | (g) | 600 | 600 | 600 | 600 | 600 | 600 |
| | Sodium hypophosphite (continuous) | (g) | 18.5 | 13 | 19.5 | 11 | 17 | 17 |
| | 15% Aqueous solution of sodium persulfate | (g) | 40 | 40 | 40 | 40 | 40 | 40 |
| | IPA concentration in IPA aqueous solution | (%) | 36 | 36 | 36 | 36 | 25 | 36 |
| | IPA aqueous solution (monomer dilution) | (g) | 270 | 270 | 270 | 270 | 270 | 270 |
| | Sodium hypophosphite (total) | (part) | 3.3 | 3.3 | 3.3 | 3.3 | 3.3 | 3.3 |
| | Sodium hypophosphite (initial) | (%) | 8 | 35 | 3 | 45 | 15 | 15 |
| | Sodium persulfate | (part) | 1.0 | 1.0 | 1.0 | 1.0 | 1.0 | 1.0 |
| | Polymerization temperature | (° C.) | 75 | 75 | 75 | 75 | 75 | 75 |
| | Time for supplying monomer | (Hr) | 4 | 4 | 4 | 4 | 4 | 4 |
| | Post addition | | — | — | — | — | — | — |
| Product | Solid content | (%) | 40 | 40 | 40 | 40 | 40 | 40 |
| | PH | | 6 | 6 | 6 | 6 | 6 | 6 |
| | Mw | | 6000 | 6000 | 6000 | 6000 | 12000 | 3800 |
| | Phosphorous acid ion | (ppm) | 40 | 430 | 22 | 900 | 100 | 110 |
| | Hypophosphorous acid ion | (ppm) | 2300 | 1400 | 2700 | 1200 | 2100 | 2100 |
| | Remained acrylic acid | (ppm) | <100 | <100 | <100 | <100 | <100 | <100 |
| Wet grinding | Integrated value under 2 μm | (%) | 100 | 100 | 100 | 100 | 100 | 100 |
| test with ground | Integrated value under 1 μm | (%) | 84 | 84 | 84 | 84 | 84 | 84 |
| calcium carbonate | Slurry viscosity on grinding day | (mPa · s) | 260 | 270 | 290 | 290 | 240 | 230 |
| | Slurry viscosity after 7 days | (mPa · s) | 2700 | 2500 | 2900 | 3000 | 2300 | 2300 |
| Dispersion test | Slurry viscosity immediately after dispersing | (mPa · s) | 330 | 340 | 360 | 370 | 310 | 320 |
| with precipitated | Slurry viscosity after 7 days | (mPa · s) | 1700 | 1800 | 2200 | 2300 | 1400 | 1400 |
| calcium carbonate | | | | | | | | |
| Silt dispersion-1 | Viscosity immediately after stirring | (mPa · s) | 36 | 37 | 42 | 43 | 33 | 34 |
| Silt dispersion-2 | Absorbance of supernatant liquid | | 0.9 | 0.9 | 0.8 | 0.7 | 1.0 | 1.0 |
| Ca capturing activity | Captured calcium ion | (mgCaCO3/g) | 400 | 400 | 370 | 380 | 410 | 420 |
| Scale inhibition test | Calcium carbonate scale inhibition ratio | (%) | 70 | 70 | 66 | 65 | 73 | 72 |
| Detergency test | Detergency ratio | (%) | 49 | 50 | 46 | 47 | 53 | 53 |

TABLE 3

| | | | Example | | | |
|---|---|---|---|---|---|---|
| | | | 16 | 17 | 18 | 19 |
| | | | Acrylic acid-based | | | |
| | | | polymer composition | | | |
| | | | E16 | E17 | E18 | E19 |
| Production | IPA aqueous solution (initial) | (g) | 500 | 500 | 500 | 500 |
| conditions | Sodium hypophosphite (initial) | (g) | 4 | 2 | 3 | 3 |
| | Acrylic acid | (g) | 600 | 600 | 600 | 600 |
| | Sodium hypophosphite (continuous) | (g) | 17 | 6 | 17 | 17 |
| | 15% Aqueous solution of sodium persulfate | (g) | 40 | 40 | 40 | 40 |
| | IPA concentration in IPA aqueous solution | (%) | Only | 70 | 36 | 36 |
| | | | water | | | |
| | IPA aqueous solution (monomer dilution) | (g) | 270 | 270 | 270 | 270 |
| | Sodium hypophosphite (total) | (part) | 3.5 | 1.3 | 3.3 | 3.3 |
| | Sodium hypophosphite (initial) | (%) | 19 | 25 | 15 | 15 |
| | Sodium persulfate | (part) | 1.0 | 1.0 | 1.0 | 1.0 |
| | Polymerization temperature | (° C.) | 75 | 75 | 65 | 83 |
| | Time for supplying monomer | (Hr) | 7 | 5 | 4 | 4 |
| | Post addition | | — | — | — | — |
| Product | Solid content | (%) | 40 | 40 | 40 | 40 |
| | PH | | 6 | 6 | 6 | 6 |
| | Mw | | 40000 | 2500 | 8000 | 4800 |
| | Phosphorous acid ion | (ppm) | 180 | 60 | 40 | 800 |
| | Hypophosphorous acid ion | (ppm) | 2100 | 1100 | 3200 | 400 |
| | Remained acrylic acid | (ppm) | <100 | <100 | 3000 | <100 |
| Wet grinding | Integrated value under 2 μm | (%) | 100 | 100 | 100 | 100 |
| test with ground | Integrated value under 1 μm | (%) | 84 | 84 | 84 | 84 |
| calcium carbonate | Slurry viscosity on grinding day | (mPa · s) | 280 | 240 | 260 | 290 |
| | Slurry viscosity after 7 days | (mPa · s) | 2400 | 2900 | 2700 | 3000 |
| Dispersion test | Slurry viscosity immediately after dispersing | (mPa · s) | 330 | 360 | 330 | 370 |
| with precipitated | Slurry viscosity after 7 days | (mPa · s) | 1900 | 1900 | 1700 | 2300 |
| calcium carbonate | | | | | | |
| Silt dispersion-1 | Viscosity immediately after stirring | (mPa · s) | 41 | 61 | 37 | 42 |
| Silt dispersion-2 | Absorbance of supernatant liquid | | 0.8 | 0.8 | 0.9 | 0.7 |
| Ca capturing activity | Captured calcium ion | (mgCaCO3/g) | 380 | 380 | 400 | 370 |
| Scale inhibition test | Calcium carbonate scale inhibition ratio | (%) | 68 | 67 | 69 | 66 |
| Detergency test | Detergency ratio | (%) | 47 | 47 | 49 | 46 |

TABLE 4

| | | | Compar- | | | Compar- | | | | |
|---|---|---|---|---|---|---|---|---|---|---|
| | | | ative | | | ative | | Comparative | | |
| | | | Example | | Example | Example | Example | Example | | |
| | | | 1 | 2 | 20 | 3 | 21 | 4 | 5 | 6 |
| | | | Acrylic acid-based polymer composition | | | | | | | |
| | | | C1 | C2 | E20 | C3 | E21 | C4 | C5 | C6 |
| Production | IPA aqueous solution (initial) | (g) | 770 | 500 | Same | Same | Same | 500 | 500 | 500 |
| conditions | Sodium hypophosphite (initial) | (g) | 0 | 0.5 | as C2 | as C2 | as C2 | 5 | 3 | 3 |
| | Acrylic acid | (g) | 600 | 600 | | | | 600 | 600 | 600 |
| | Sodium hypophosphite (continuous) | (g) | 20 | 1.5 | | | | 27 | 17 | 17 |
| | 15% Aqueous solution of sodium persulfate | (g) | 40 | 40 | | | | 40 | 40 | 40 |
| | IPA concentration in IPA aqueous solution | (%) | 36 | 36 | | | | 36 | 36 | 36 |
| | IPA aqueous solution (monomer dilution) | (g) | 0 | 270 | | | | 270 | 270 | 270 |
| | Sodium hypophosphite (total) | (part) | 3.3 | 0.3 | | | | 5.3 | 3.3 | 3.3 |
| | Sodium hypophosphite (initial) | (%) | 0 | 25 | | | | 16 | 15 | 15 |
| | Sodium persulfate | (part) | 1.0 | 1.0 | | | | 1.0 | 1.0 | 1.0 |
| | Polymerization temperature | (° C.) | 80 | 75 | | | | 75 | 55 | 85 |
| | Time for supplying monomer | (Hr) | 4 | 4 | | | | 4 | 4 | 4 |
| | Post addition | | — | — | (a) | (b) | (a) + (b) | — | — | — |
| Product | Solid content | (%) | 40 | 40 | 40 | 40 | 40 | 40 | 40 | 40 |
| | PH | | 4 | 6 | 6 | 6 | 6 | 6 | 6 | 6 |
| | Mw | | 6000 | 20000 | 20000 | 20000 | 20000 | 2500 | 22000 | 4200 |
| | Phosphorous acid ion | (ppm) | 10 | 10 | 150 | 10 | 150 | 1300 | 10 | 3000 |
| | Hypophosphorous acid ion | (ppm) | 5500 | 100 | 100 | 2000 | 2000 | 6000 | 6000 | 300 |
| | Remained acrylic acid | (ppm) | <100 | <100 | <100 | <100 | <100 | <100 | 10000 | <100 |
| Wet grinding | Integrated value under 2 μm | (%) | 100 | 100 | 100 | 100 | 100 | 100 | 100 | 100 |
| test with ground | Integrated value under 1 μm | (%) | 84 | 84 | 84 | 84 | 84 | 84 | 84 | 84 |
| calcium carbonate | Slurry viscosity on grinding day | (mPa · s) | 370 | 420 | 300 | 370 | 250 | 400 | 410 | 400 |
| | Slurry viscosity after 7 days | (mPa · s) | 5400 | 6200 | 3100 | 5600 | 2200 | 6600 | 5400 | 5600 |
| Dispersion test | Slurry viscosity immediately after dispersing | (mPa · s) | 470 | 490 | 380 | 450 | 330 | 490 | 470 | 480 |
| with precipitated | Slurry viscosity after 7 days | (mPa · s) | 4200 | 4100 | 2500 | 3700 | 1300 | 4200 | 3900 | 4100 |
| calcium carbonate | | | | | | | | | | |
| Silt dispersion-1 | Viscosity immediately after stirring | (mPa · s) | 59 | 60 | 43 | 56 | 34 | 61 | 59 | 60 |
| Silt dispersion-2 | Absorbance of supernatant liquid | | 0.5 | 0.4 | 0.7 | 0.5 | 1.0 | 0.5 | 0.5 | 0.5 |
| Ca capturing activity | Captured calcium ion | (mgCaCO3/g) | 310 | 310 | 360 | 330 | 410 | 320 | 320 | 320 |
| Scale inhibition test | Calcium carbonate scale inhibition ratio | (%) | 59 | 59 | 65 | 61 | 72 | 60 | 61 | 60 |
| Detergency test | Detergency ratio | (%) | 39 | 39 | 46 | 41 | 52 | 40 | 40 | 40 |

The symbols in column of “post addition” described for production conditions in Tables 1 to 4 have following meanings.

(a): Sodium phosphite was added to the acrylic acid-based polymer composition
(b): Sodium hypophosphite was added to the acrylic acid-based polymer composition

The acrylic acid-based polymer compositions E1 to E19 obtained in Example 1 to 19 all contain phosphorous acid ion within the range defined by the present invention. When they were used in an application for a dispersant, a detergent, or an inorganic precipitation inhibitor, good performances were exhibited.

Acrylic acid-based polymer compositions E20 and E21 are ones in which a phosphorous acid compound is further added to the acrylic acid-based polymer composition C2 having a phosphorous acid ion concentration which does not satisfy the amount defined by the present invention, but good results were obtained for each performance evaluation, similar to E1 to E19.

On the other hand, both Comparative Example 1, which is a test example in which sodium hypophosphite as a chain transfer agent is not added to a reactor before supplying the monomer, and Comparative Example 2, which uses a little amount of sodium hypophosphite, exhibited poor performances such as dispersion performance, a scale inhibition rate, and detergency, because the concentration of the phosphorous acid ion contained in the obtained acrylic acid-based polymer was low. Comparative Example 5 showed a similar result in which oxidation of sodium hypophosphite did not progress due to low polymerization temperature, consequently yielding low phosphorous acid ion concentration.

Moreover, since Comparative Example 4 in which the usage amount of sodium hypophosphite was high and Comparative Example 6 in which the polymerization temperature was high led to acrylic acid-based polymer compositions having excessively high phosphorous acid ion concentration, unsatisfactory results were obtained in terms of various performances.

### INDUSTRIAL APPLICABILITY

According to the present invention, an acrylic acid-based polymer composition containing a specific amount of phosphorous acid ion can be efficiently obtained. Further, the acrylic acid-based polymer composition exhibits a very excellent performance when used for applications including a pigment dispersant, a detergent, and an inorganic precipitation inhibitor.

1. A method for producing a composition comprising an acrylic acid-based polymer, the method comprising:
supplying monomers comprising acrylic acid to a reactor comprising from 1% to 50% by mass of a total amount of a hypophosphorous acid compound; and
polymerizing the monomers, thereby obtaining the composition,
wherein the hypophosphorous acid compound is used in an amount of 0.5 to 4.5 parts by mass based on 100 parts by mass of a total of the monomers comprising acrylic acid.

2. The method of claim 1, wherein the polymerization is performed in a polymerization solvent, which is a mixture solution of water and isopropyl alcohol.

3. The method of claim 2, wherein said polymerizing is performed at a polymerization temperature of from 68° C. to 82° C.

4. The method of claim 1, wherein the hypophosphorous acid compound is at least one compound selected from the group consisting of a sodium salt, a potassium salt, a lithium salt, a calcium salt, a magnesium salt, and a barium salt of hypophosphorous acid.

5. The method of claim 1, wherein, during said supplying, a polymerization initiator comprising a persulfate is supplied with the monomer to the reactor.

6. The method of claim 1, wherein the composition comprises a phosphorous acid ion of from 20 to 1,000 ppm by mass based on a solid content of the acrylic acid-based polymer.

7. The method of claim 1, wherein the composition comprises a hypophosphorous acid ion of from 200 to 5,000 ppm by mass based on a solid content of the acrylic acid-based polymer.

8. The method of claim 1, wherein the acrylic acid-based polymer has a weight average molecular of from 3,000 to 30,000.

9. The method of claim 1, wherein the hypophosphorous acid compound is employed as a chain transfer agent during the polymerization.

10. The method of claim 1, wherein the polymerizing is performed in the presence of a radical polymerization initiator, wherein the amount of the radical polymerization initiator is from 0.1% to 15% by weight based on a total of the monomers.
